(19) United States
(12) Patent Application Publication
(10) Pub. No.: US 2009/0099884 A1
(43) Pub. Date: Apr. 16, 2009

(54) METHOD AND SYSTEM FOR DETECTING FRAUD BASED ON FINANCIAL RECORDS

(75) Inventors: Ralph Samuel Hoefelmeyer, Colorado Springs, CO (US); Chau Nguyen Dang, Cary, NC (US); April Arch-Espigares, Tulsa, OK (US)

Correspondence Address: VERIZON;PATENT MANAGEMENT GROUP, 1320 North Court House Road, 9th Floor, ARLINGTON, VA, 22201-2909, US

(73) Assignees: MCI Communications Services, Inc., Ashburn, VA (US); Verizon Business Network Services Inc., Ashburn, VA (US)

(21) Appl. No.: 11/872,490

(22) Filed: Oct. 15, 2007

(51) Int. Cl. G06Q 10/00; G06F 17/30; G06F 17/40

(52) U.S. Cl. 705/7

(57) ABSTRACT

An approach is disclosed for detecting fraud in financial records of a network subscriber. Financial records are received and impersonal data are extracted. Financial record data are processed to conform to a normalized format. Normalized records can be correlated into groups linked to respective sources such as, for example, an individual, a business entity, or a healthcare practitioner. Digits contained in this data are analyzed to determine a pattern that is indicative of fraud. An alert, to the fact that fraud has been detected with respect to an identified plurality of records if such determination has been made, is then generated.

### BACKGROUND OF THE INVENTION

Activities that are dependent upon the maintenance of financial records are subject to serious concerns with respect to fraudulent practices. In the healthcare industry, for example, healthcare fraud costs Americans at least one hundred billion dollars per year. Healthcare fraud is the intentional deception or misrepresentation of healthcare transactions by a provider, employer group, or member for the sake of receiving an unauthorized benefit or financial gain. Individuals convicted of this crime face imprisonment and substantial fines.

Types of fraud are varied, including kickbacks, billing for services not rendered, billing for unnecessary equipment, and billing for services performed by a lesser qualified person. The health care providers who commit these fraud schemes encompass all areas of health care, including hospitals, home health care, ambulance services, doctors, chiropractors, psychiatric hospitals, laboratories, pharmacies, and nursing homes.

Individual investigation of a vast number of records in scattered locations for the purpose of fraud discovery is a daunting endeavor, not only in the healthcare industry but in any practice that involves financial accountability. The privacy requirements of government regulations regarding nondisclosure of personal information further complicate such investigation.

The need exists for an effective automated approach for fraud detection. Such an approach should ensure compliance with governmental privacy requirements and similar restrictions applicable to accounting practice standards.

### BRIEF DESCRIPTION OF THE DRAWINGS

FIG. 1 is a diagram of a communication system capable of providing fraud detection, in accordance with an exemplary embodiment;

FIG. 2 is a flowchart of a fraud detection process in operation of the system of FIG. 1;

FIG. 3 is a diagram of the functional components of a fraud detection system, in accordance with an exemplary embodiment;

FIG. 4 is a flowchart of a process for detecting and handling a fraudulent activity, according to an exemplary embodiment;

FIG. 5 is a diagram of the components of the fraud detection system of FIG. 3; and

FIG. 6 is a diagram of a computer system that can be used to implement various exemplary embodiments.

### DESCRIPTION OF THE PREFERRED EMBODIMENT

An apparatus, method, and software for providing fraud detection of financial data are described. In one embodiment, financial records of a network subscriber are received and impersonal data are extracted. Digits contained in this data are analyzed to determine a pattern that is indicative of fraud. An alert, to the fact that fraud has been detected with respect to an identified plurality of records if such determination has been made, is then generated.

Financial record data are processed to conform to a normalized format. Normalized records can be correlated into groups linked to respective sources such as, for example, an individual, a business entity, or a healthcare practitioner. Analysis of digit data may be performed in accordance with Benford's law, wherein a significant pattern can be recognized in a group of records group. As new records are accumulated, evaluation for fraud detection can be repeated. An historical database of evaluated events can be maintained. The historical database may include identification of the number of events evaluated, anomalous events, false positive events, and actual fraudulent events. Status reports for arbitrary time periods can be issued. The customer can then investigate in detail based on the fraud information generated by alerts and status reports.

In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various exemplary embodiments are described with respect to a fraud detection as applied to healthcare services, it is contemplated that these embodiments have applicability to any enterprise that is dependent upon financial records.

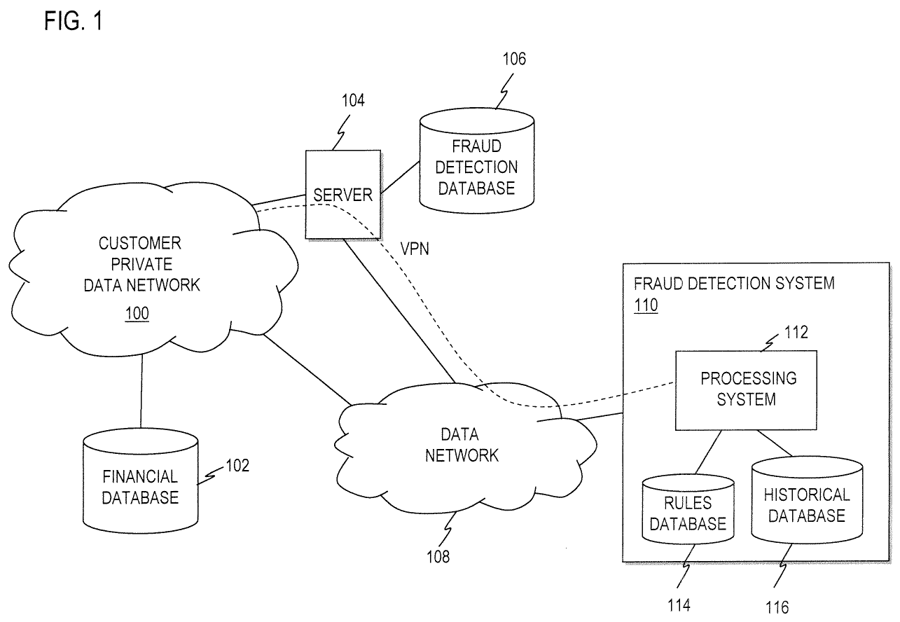

FIG. 1 is a diagram of a communication system capable of providing fraud detection, in accordance with an exemplary embodiment. A customer, such as a state medi-care agency, maintains a private data network 100 that receives record data in electronic form for storage in database 102. The data encompass medical or pharmaceutical transactions that have financial implications and may be stored in Structured Query Language (SQL) format in a medical record database and a financial record database. Records in the database 102 can be associated with individual patients, doctors, hospitals and any healthcare provider entities.

It is noted that instances of provider fraud have included billing for services, procedures and/or supplies that were not provided; billing that appears to be a deliberate application for duplicate payments of services; billing for non-covered services as covered items; performing medically unnecessary services in order to obtain insurance reimbursement; incorrect reporting of diagnoses or procedures to maximize insurance reimbursement; misrepresentations of dates, descriptions of services, or subscribers/providers; providing false employer group and/or group membership information. Instances of member fraud have included using someone else's coverage or insurance card; filing claims for services or medications not received; forging or altering bills or receipts. Furthermore, instances of employer fraud have included false portrayal of an employer group to secure healthcare coverage; enrolling individuals who are not eligible for healthcare coverage; changing dates of hire or termination to expand dates of coverage.

Another consideration involves regulatory compliance, such as the Health Insurance Portability and Accountability Act of 1996 (HIPAA), which was enacted to provide better access to health insurance as well as to toughen the law concerning healthcare billing fraud. Included in the Act is a strict privacy rule that controls disclosure of Protected Health Information (PHI). PHI is any information about health status, provision of health care, or payment for health care that can be linked to an individual in any part of a patient's medical record or payment history.

Referring back to FIG. 1, network 100 is coupled to, for instance, a computing device, such as server 104 on the customer premises. The server 104 may comprise a hardened Linux appliance, for example, and be configured to established a secure link to the fraud detection system 110 over a virtual private network (VPN) connection. Server 104 can gather data, normalize each medical record for specified parameters, and place the record in fraud detection database 106. Data gathering may be performed with a Perl script mechanism without the need for customer interaction. Parameters may include, for example, medical billing codes, doctor, hospital, lab, geographic location, costs, and payments. Implementation of database crawler software enables correlation of normalized medical records with associated accounting records, the correlation stored in fraud detection database 106. As data must be treated in a HIPAA compliant manner, one or more unique identifiers are kept with each record. The system architecture ensures that each element is guarded and secured, in order to prosecute fraudulent activity appropriately.

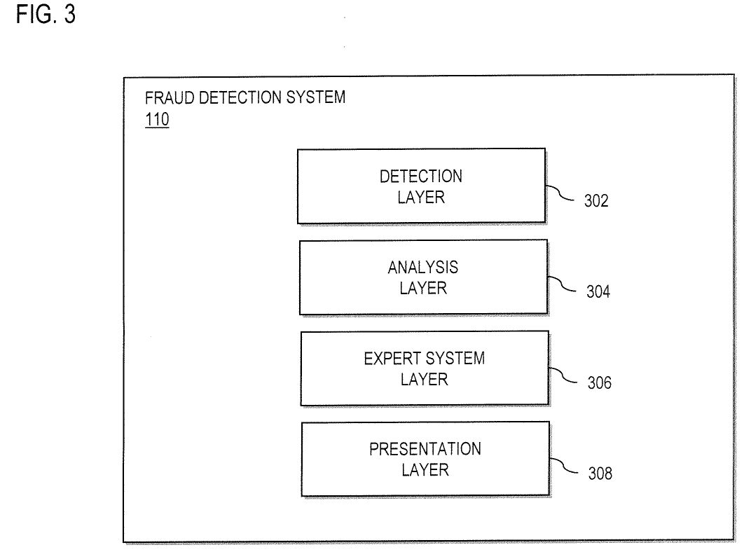

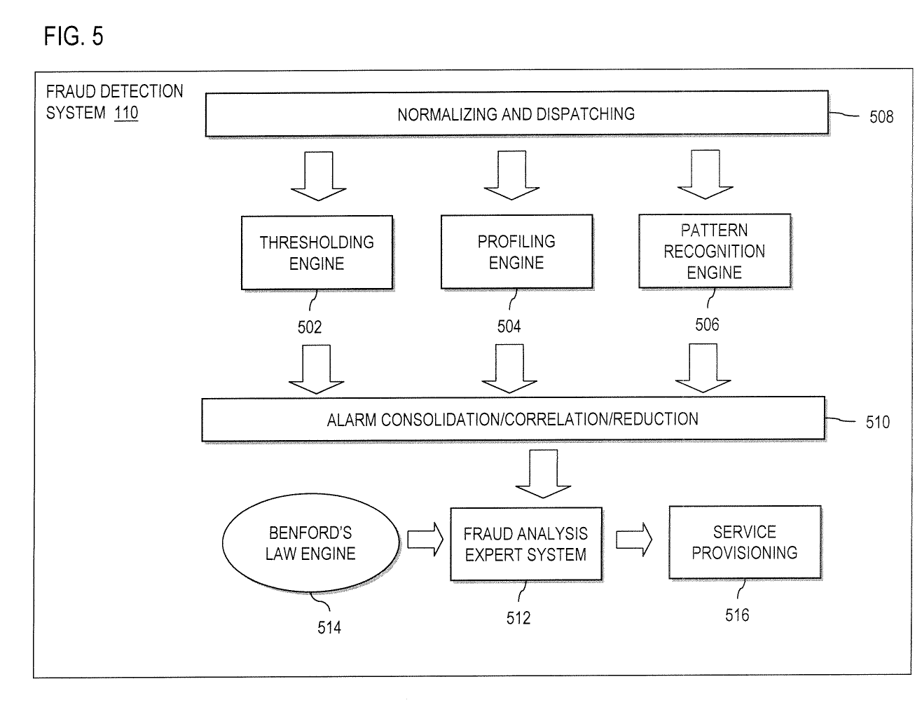

Server 104 is coupled to data network 108 for communication with fraud detection system 110. The fraud detection database can be compressed and encrypted in server 104 and transmitted to fraud detection system 110. Data transmission can comply, for example, with the known 128 Advanced Encryption Standard. Fraud detection system 110 comprises processing system 112, rules database 114, and historical database 116. Normalized records are then subjected to analysis by processing system 112 in accordance with rules stored in database 114. The fraud detection system 110 is more fully described in below with respect to FIGS. 3 and 5.

It is to be understood that the illustrated networks encompass a number of commonly known components. For simplicity and efficiency of explanation, only those elements that facilitate understanding of the described underlying concepts are illustrated.

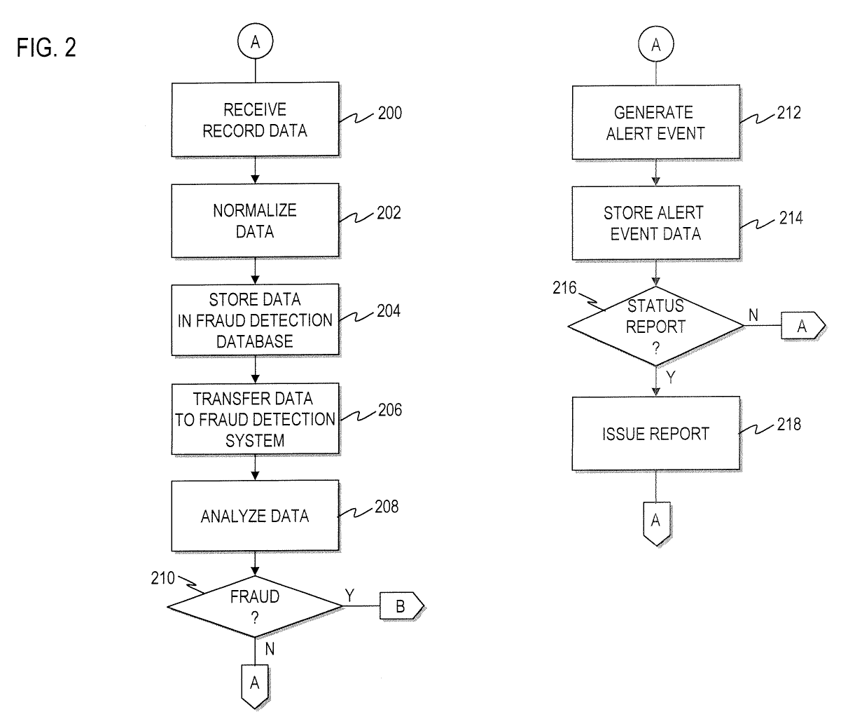

FIG. 2 is a flowchart of a fraud detection process in operation of the system of FIG. 1. At step 200, data records are received by the customer and accumulated. In the exemplified embodiment, these records contain medical records as well as related financial records. At step 202, each medical record is normalized to a format comprising established parameters by server 104 without identifying personal information. Each medical record is correlated with an associated accounting or financial record. These records are stored in fraud detection database 106 at step 204. Server 104 and database 106 are located at customer premises.

The data in fraud detection database 106 are compressed and encrypted for transfer to fraud detection system 110 at step 206. Data transmission can occur at regularly scheduled intervals or by customer request. For example, the customer may have reason to investigate the integrity of the database in response to a significant occurrence. The transferred data are analyzed, at step 208, by the processing system 112 in accordance with rules for analysis stored in rules database 114. The analysis rules may apply heuristic threshold techniques, artificial neural networks for patterns, clustering analysis to determine suspect clusters of activity, trend analysis, Benford's law for accounting fraud, and other data mining techniques.

For example, Benford's law (also known as the first-digit law) states that in lists of numbers from many real-life sources of data, the leading digit is 1 almost one third of the time, and larger numbers occur as the leading digit with less and less frequency as they grow in magnitude, to the point that 9 is the first digit less than one time in twenty. Based on the observation that real-world measurements are generally distributed logarithmically, the logarithm of a set of real-world measurements is generally distributed uniformly. Accounting abnormalities can thus be detected by analysis of the digits contained in the record data associated with a particular source.

Conclusions of the analyses performed in step 208 are formulated in step 210. If no indication of fraud has been found, the process reverts to step 200 for accumulation of new records. If it is concluded at step 210 that fraud is indicated, an alert is generated at step 212 and forwarded to the customer via data network 108. Pertinent data associated with the generated alert are stored in the historical database 116 at step 214.

Database 116 also maintains event information related to previous evaluations as a basis for generating status reports. While such reports may be generated at specified intervals, a status report may be issued at the customer's request. At step 216, determination is made as to whether a status report is to be generated. If not, the process reverts to step 200 for accumulation of new records. If a status report has been required, a status report is generated at step 218 and forwarded to the customer via data network 108. The process reverts to step 200 for accumulation of new records.

FIG. 3 is a diagram of the functional components of a fraud detection system, in accordance with an exemplary embodiment. The fraud detection system 110 detects fraud by comparing event records with thresholding rules and profiles. Violations result in the generation of alarms. Multiple alarms are correlated into fraud cases based on common aspects of the alarms, thus reducing the amount of analysis that is performed on suspected incidents of fraud.

The system 110, according to one embodiment, automatically acts upon certain cases of detected fraud to reduce losses stemming therefrom. In addition, live analysts can initiate additional actions. In a parallel operation, calling patterns are analyzed via event records to discern new methods or patterns of fraud. From these newly detected methods of fraud, new thresholds and profiles are automatically generated.

Referring to FIG. 3, the present invention is illustrated as implemented as a fraud detection system 110. The fraud detection system 110 includes a detection layer 302, an analysis layer 304, an expert systems layer 306 and a presentation layer 308.

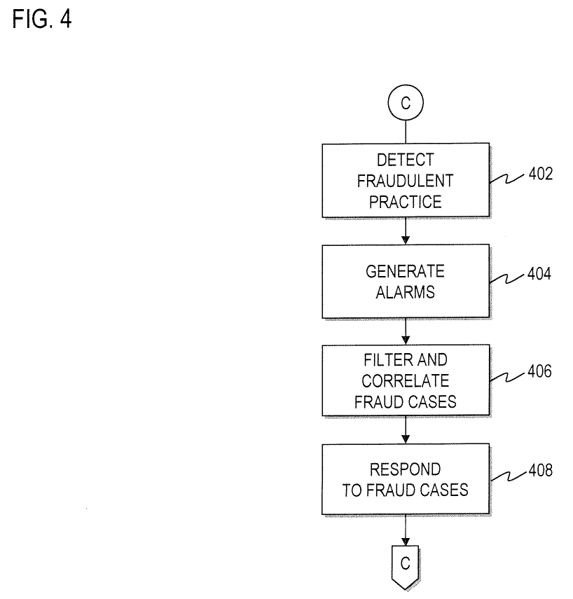

FIG. 4 is a flowchart of a process for detecting and handling a fraudulent activity, according to an exemplary embodiment. By way of example, this process is described with respect to the fraud detection system 110 shown in FIG. 5. In step 402, event records are analyzed by detection layer 302 for possible fraud. Subsequently, alarms are generated, per step 404.

Detection layer 302 is scalable and distributed with a configurable component to allow for customization in accordance with user requirements. Detection layer 302 includes, for example, three classes of processing engines, which are three distinct but related software processes, operating on similar hardware components. These three classes of engines include a rules-based thresholding engine 502, a profiling engine 504 and a pattern recognition engine 506. These scalable and distributed engines can be run together or separately and provide the system with unprecedented flexibility.

A normalizing and dispatching component 508 can be employed to normalize event records and to dispatch the normalized records to the various processing engines. Normalization is a process or processes for converting variously formatted event records into standardized formats for processing within detection layer 302. The normalizing process is dynamic in that the standardized formats can be varied according to the needs of the user.

Dispatching is a process which employs partitioning rules to pass some subset of the normalized event records to particular paths of fraud detection and learning. Thus, where a particular processing engine requires only a subset of the available information, time and resources are conserved by sending only the necessary information.

Rules-based thresholding engine 502 constantly reads real-time event records from network information concentrator and compares these records to selected thresholding rules. If a record exceeds a thresholding rule, the event is presumed fraudulent and an alarm is generated. Thresholding alarms are sent to analysis layer 304.

Profilin engine 504 constantly reads real-time event records from network information concentrator and from other possible data sources which can be specified in the implementation layer by each user architecture. Profiling engine 504 then compares event data with appropriate profiles from a profile database. If an event represents a departure from an appropriate profile, a probability of fraud is calculated based on the extent of the departure and an alarm is generated. The profiling alarm and the assigned probability of fraud are sent to an analysis layer 304.

Event records are also analyzed in real-time by an artificial intelligence-based pattern recognition engine 506. This Al analysis will detect new fraud profiles so that threshold rules and profiles are updated dynamically to correspond to the latest methods of fraud.

Pattern recognition engine 506 permits detection layer 302 to detect new methods of fraud and to update the fraud detecting engines, including engines 502 and 504, with new threshold rules and profiles, respectively, as they are developed. In order to detect new methods of fraud and to generate new thresholds and profiles, pattern recognition engine 506 operates on all event records including data from network information concentrator through all other levels of the system, to discern anomalous call patterns which can be indicative of fraud.

Pattern recognition engine 506 collects and stores volumes of event records for analyzing financial histories. Utilizing artificial intelligence (AI) technology, pattern recognition engine 506 analyzes financial histories to learn normal patterns and determine if interesting, abnormal patterns emerge. When such an abnormal pattern is detected, pattern recognition engine 506 determines if this pattern is to be considered fraudulent.

Al technology allows pattern recognition engine 506 to identify, using historical data, types of patterns to look for as fraudulent. Pattern recognition engine 506 also uses external data from billing and accounts receivable (AR) systems as references to current accumulations and payment histories. These references can be applied to the pattern recognition analysis process as indicators to possible fraud patterns.

Once pattern recognition engine 506 has established normal and fraudulent patterns, it uses these results to modify thresholding rules within the thresholding engine 502. Pattern recognition engine 506 can then modify a thresholding rule within thresholding engine 502 which will generate an alarm if event data is received which reflects that particular pattern. Thus, by dynamically modifying threshold rules, the system is able to keep up with new and emerging methods of fraud, thereby providing an advantage over conventional parametric thresholding systems for fraud detection.

Similarly, once normal and fraudulent patterns have been established by pattern recognition engine 506, pattern recognition engine 506 updates the profiles within the profile database (not shown). This allows profiles to be dynamically modified to keep up with new and emerging methods of fraud.

In step 406, alarms are filtered and correlated by analysis layer 304. For example, suppose a threshold rule generates an alarm if more the financial records indicate sporadic expenses made within a predetermined time frame.

A correlation scheme for step 406 can combine multiple alarms into a single fraud case indicating that a particular account has exceeded two different threshold rules. In addition, if a pattern recognition engine is employed, a new threshold rule can be generated to cause an alarm to be generated in the event of any future attempted use of the account.

Alarms which are generated by the detection layer 302 are sent to the analysis layer 304. Analysis layer 304 analyzes alarm data and correlates different alarms which were generated from the same or related events and consolidates these alarms into fraud cases. This reduces redundant and cumulative data and permits fraud cases to represent related fraud occurring in multiple services. For example, different alarms can be received for possibly fraudulent use of expense accounts. The correlation process within analysis layer 304 can determine that fraudulent activity is occurring. An alarm database (not shown), for example, can be utilized to stores alarms received from the detection layer 302 for correlation.

Analysis layer 304 prioritizes the fraud cases according to their probability of fraud so that there are likely to be fewer false positives at the top of the priority list than at the bottom. Thus, fraud cases which are generated due an occasional exceeding of a threshold by an authorized user or by an abnormal spending or invoicing pattern by an authorized user. The analysis layer 304 employs artificial intelligence algorithms for prioritization. Alternatively, detection layer 302 rules can be customized to prevent such alarms in the first place.

In one embodiment, analysis layer 304 includes a software component 510 that performs the consolidation, correlation, and reduction functions. Software component 510 makes use of external data from, for example, billing and accounting systems (not shown) in the correlation and reduction processes. The component 510, in an exemplary embodiment, can include an alarm database.

In step 408, consolidated fraud cases are sent to expert system layer 306 for automatically executing one or more tasks in response to certain types of fraud cases. Thus, in the example above, automatic action can include notifying the responsible healthcare company of the suspected fraud so that they can take fraud-preventive action. In addition, any pending calls can be terminated if such functionality is supported by the network.

According to one embodiment, the expert system layer 306 includes a fraud analysis expert system 512, which applies expert rules to determine priorities and appropriate actions. The system 512 can utilize an engine 514 that implements Benford's law, as explained with respect to process of FIG. 2. A customized expert system can employed and programmed using a rules-based language appropriate for expert systems.

Expert system 512 includes interfaces to several external systems for the purpose of performing various actions in response to detected fraud. For example, the expert system 512 can include an interface to a service provisioning system 516 for retrieving data relating to services provided to a customer and for initiating actions to be taken on a customer's service. Expert system 512 can employ artificial intelligence for controlling execution of automated or semi-automated actions.

Cases of suspected fraud can alternatively be directed to live operators, via a presentation layer 308, so that they can take some action for which the automated system is not capable. Presentation layer 308 can include one or more workstations connected to the each other and to expert system 512 via a local area network LAN, a wide area network (WAN), or via any other suitably interfacing system.

Fraud data that has been collected and processed by the detection, analysis and expert system layers can thus be presented to human analysts via the workstations. Presentation layer 308 also allows for human analysts operating from workstations to initiate actions to be taken in response to detected fraud. Such actions are executed through interfaces to various external systems. Presentation layer 308 can include a customized, flexible scripting language which forms part of the infrastructure component of the system.

The processes described herein for fraud detection may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

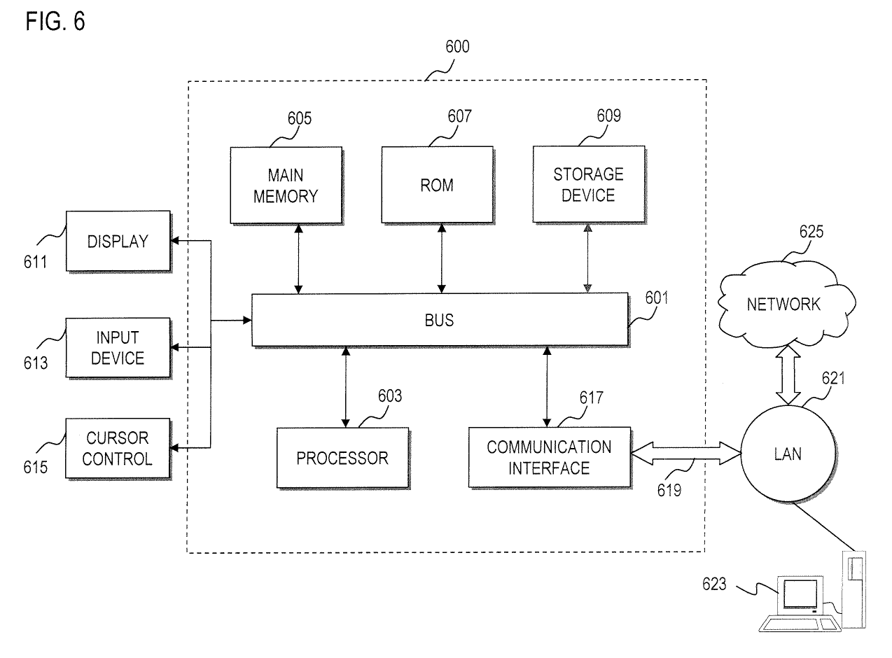

FIG. 6 illustrates computing hardware (e.g., computer system) 600 upon which an embodiment according to the invention can be implemented. The computer system 600 includes a bus 601 or other communication mechanism for communicating information and a processor 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for controlling cursor movement on the display 611.

According to an embodiment of the invention, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. Thus, embodiments of the invention are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an embodiment of the invention through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that flow. The specification and the drawings are accordingly to be regarded in an illustrative rather than restrictive sense.

What is claimed is:

1. A method comprising:
receiving financial records of a network subscriber;
extracting impersonal data from the financial records; and
analyzing digits of the impersonal data to determine whether a significant event can be identified.

2. A method as recited in claim 1, wherein the step of analyzing comprises detecting a pattern of digits in an identified plurality of the records that are indicative of fraud; and further comprising:
generating an alert that fraud has been detected with respect to the identified plurality of records.

3. A method as recited in claim 2, wherein the financial records correspond to healthcare data, accounting data, products data, or services data.

4. A method as recited in claim 1, wherein in the step of analyzing comprises processing data in accordance with Benford's law.

5. A method as recited in claim 4, further comprising:
normalizing the financial records; and
wherein the step of analyzing further comprises correlating the normalized records into groups linked to respective sources, and the identified plurality of normalized records are common to one of the groups.

6. A method as recited in claim 5, wherein one of the groups is linked to either an individual, a business entity, or a healthcare practitioner.

7. A method as recited in claim 5, further comprising: accumulating additional records to expand the database;
subsequently repeating the evaluating step for the expanded database;
maintaining a historical database of evaluated events; and
issuing status reports for arbitrary time periods.

8. A method as recited in claim 7, wherein the historical database comprises the number of events evaluated, anomalous events, false positive events, and actual fraudulent events.

9. An apparatus comprising:
a communications interface configured to receive financial records of a subscriber; and
a processor coupled to the communications interface, the processor configured to extract impersonal data from the financial records and to analyze digits of the impersonal data to determine whether a significant event can be identified.

10. An apparatus as recited in claim 9, wherein the processor is further configured to detect a pattern of digits in an identified plurality of the records that are indicative of fraud, and to generate an alert that fraud has been detected with respect to the identified plurality of records.

11. An apparatus as recited in claim 10, wherein the financial records correspond to healthcare data, accounting data, products data, or services data.

12. An apparatus as recited in claim 9, wherein analysis of the digits is performed in accordance with Benford's law.

13. An apparatus as recited in claim 12, wherein the processor is further configured to normalize the financial records, and to correlate the normalized records into groups linked to respective sources, the identified plurality of normalized records being common to one of the groups.

14. An apparatus as recited in claim 13, wherein one of the groups is linked to either an individual, a business entity, or a healthcare practitioner.

15. An apparatus as recited in claim 13, further comprising:
a historical database configured to store evaluated events for report generation.

16. An apparatus as recited in claim 15, wherein the historical database comprises the number of events evaluated, anomalous events, false positive events, and actual fraudulent events.

17. A system comprising:
a remote fraud detection unit coupled to a server through a data network, wherein:
the server is configured to process impersonal data of a financial database and to store the processed data in a normalized format; and
the fraud detection unit is configured to detect a pattern of digits in an identified plurality of the records in the stored normalized data that are indicative of fraud.

18. A system as recited in claim 17, wherein the fraud detection unit is configured to process data in accordance with Benford's law.

19. A system as recited in claim 17, wherein the financial database comprises healthcare records.

20. A system as recited in claim 17, wherein the identified plurality of records is linked to a common source including one of an individual, a business entity, or a healthcare practitioner.

21. A system as recited in claim 17, wherein the fraud detection unit comprises;
a processor and a rules database;
wherein the processor is configured to process data received from the server in accordance with rules contained in the rules database.

22. A system as recited in claim 21, wherein the fraud detection unit further comprises an historical database containing data representing a number of events evaluated, anomalous events, false positive events, and actual fraudulent events.
